(19) United States
(12) Patent Application Publication
(10) Pub. No.: US 2004/0016390 A1
(43) Pub. Date: Jan. 29, 2004

(54) Short-term indenting memory device and method

(76) Inventor: Robert E. McMillan, Concord, NH (US)

Correspondence Address: SCOTT C. RAND, ESQ., MCLANE, GRAF, RAULERSON & MIDDLETON, PA, 900 ELM STREET, P.O. BOX 326, MANCHESTER, NH, 03105-0326, US

(21) Appl. No.: 10/378,474

(22) Filed: Mar. 3, 2003

Related U.S. Application Data
(60) Provisional application No. 60/399,199, filed on Jul. 29, 2002.

(51) Int. Cl. G01L 5/00

(52) U.S. Cl. 116/212

(57) ABSTRACT

A short-term indenting memory device (10) comprises a plurality of flexible tubes (12) in bundled, woven or other intersecting relation to one another to form a mat or pad. The flexible tubes (12) comprise a sealed interior space (16) containing a viscous fluid (18). When an object (22) is set on the pad (10), an indentation (20) is formed therein which persists for some time after the object (12) is removed. In a further aspect, a method of providing a reminder comprises providing an indenting memory device (10) in accordance with this teaching. An object (22) set on a surface (14) thereof creates an indentation (20) which persists for a period of time after the object (22) is removed, thereby providing an indicium of whether the object (22) was previously present on the memory device (10).

### CROSS REFERENCE TO RELATED APPLICATION

This application claims the benefit under 35 U.S.C. § 119(e) of U.S. provisional application Serial No. 60/399,199 filed Jul. 29, 2002. Said provisional application is incorporated herein by reference in its entirety.

### BACKGROUND OF THE INVENTION

The present invention relates to a mat or pad having a short-term indenting memory and method employing the same. It is to be understood that the description of the invention herein is intended to be exemplary and explanatory only.

### SUMMARY OF THE INVENTION

The present development is directed to an indenting memory device. In a preferred aspect, the device comprises a plurality of flexible tubes, e.g., in woven or intersecting relation to one another to form a mat or pad. The flexible tubes comprise a sealed interior space containing a viscous fluid. When an object is set on the pad, an indentation or deformation is formed therein which persists for some time after the object is removed.

In a further aspect, the invention is directed to a method of providing a reminder, which comprises providing an indenting memory device in accordance with this teaching. An object is set on a surface thereof to create an indentation and thereafter removed. The indentation persists for some period of time after the object is removed, thereby providing an indicium of whether the object was previously present on the memory device.

The present invention finds utility, for example, in conjunction with the use of one or more objects or items which are set out temporarily for use. An item to be used is first set out onto the memory pad. After the item is used and put away, the indentation created by the item serves as a memory aid to indicate whether the item has been used. Exemplary uses of the present invention include, but are not limited to, temporarily carrying ingredients such as spices and the like set out for cooking, vials or containers containing medicine or other substance to be dispensed, and so forth.

### BRIEF DESCRIPTION OF THE DRAWINGS

The accompanying drawings, which are incorporated in and constitute a part of the specification, illustrate embodiments of the invention and together with the description of the invention herein, serve to explain the principles of the invention.

FIG. 1 is a top plan view of an exemplary indenting memory device of the present invention.

FIG. 2 is an enlarged, fragmentary view of the device shown in FIG. 1.

FIGS. 3 and 4 are cross-sectional views of exemplary fluid-filled tubes which may be used to form the memory device of FIGS. 1 and 2.

FIG. 5 is perspective view illustrating the manner of operation of the invention.

### DETAILED DESCRIPTION OF THE PREFERRED EMBODIMENT

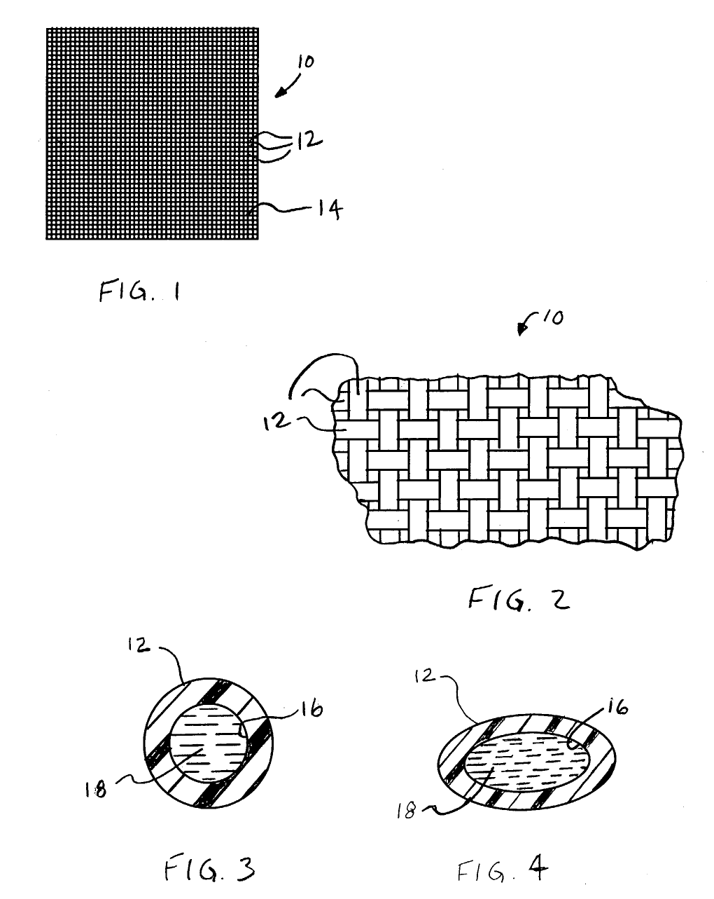

Referring now to FIGS. 1-4, a short-term memory device comprises a mat or pad 10 formed of a plurality of flexible, fluid-filled tubes 12 defining a generally planar surface 14. The tubes may be, e.g., up to about 2 mm in diameter, preferably up to about 1 mm in diameter, and more preferably less than 1 mm. Although the tubes 12 of the pad 10 are depicted generally in a woven arrangement, it will be recognized that any other arrangement of the tubes may be employed, including intersecting, unidirectional, fastened, or bundled arrangements, and so forth. Also, although the illustrated embodiment depicts a pad comprising solely fluid-filled tubes 12, also contemplated that the fluid-filled tubes 12 may be interspersed with nontubular materials such as conventional textile materials, so long as the desired indenting memory is retained. The flexible tubes 12 may optionally be covered with a flexible covering material (not shown) such as fabric or the like, e.g., to provide a desired finish.

The tubes are formed of a resilient, flexible, deformable, or elastic material, such as rubber, plastic or polymeric materials, or the like. Each tube has sealed ends and contains a hollow channel or passage 16 running along its length. The channels 16 contain a highly viscous fluid 18. The fluid 18 preferably has a viscosity in the range of from about 100,000 centistokes to several million centistokes, e.g., about five to ten million centistokes, or higher. Exemplary fluid materials include, but are not limited to, silicones, fluorocarbon materials, gels, and the like.

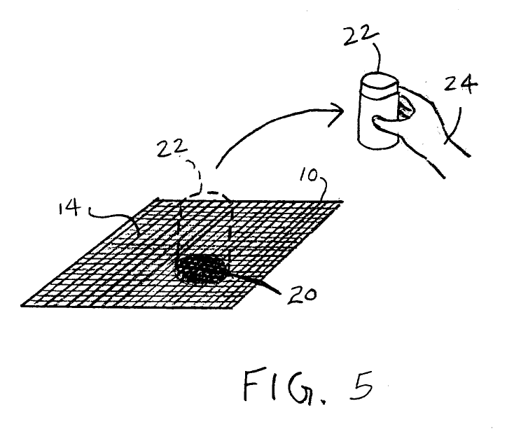

In the embodiments of FIGS. 3 and 4, the channels 16 of the tubes 12 are illustrated as being essentially filled with the viscous fluid 18. However, it is also contemplated that the channels 16 be less than completely filled to facilitate movement of the fluid 18 within the channels from a compressed region to a noncompressed region. This is particularly advantageous when the material forming the tubes 12 is flexible but is not highly stretchable.

The tube 12 of the embodiment of FIG. 3 is depicted as having a circular cross-sectional shape. However, the tubes 12 may also have a noncircular cross-sectional profile. FIG. 4 depicts an alternative, preferred exemplary tube 12 having a generally oval or elliptical cross section. It will be recognized that any other geometrical cross-sectional shape may be employed, including but not limited to rectangular or other polygonal shape, semicircular, hemielliptical, and so forth. An elliptical or other noncircular cross-sectional profile of the tubes 12 is advantageous when the tubes 12 are flexible or deformable but not highly stretchable. That is, when fluid is forced from a compressed region of the pad 10 to a noncompressed region during use, the cross-sectional shape of the tubes 12 can flex or deform to approach that of a circle, thereby increasing the volume of the channels 16 in the noncompressed regions and thus accommodating the fluid 18 that is forced out of the tubes in the compressed region.

Referring now to FIG. 5, and with continued reference to FIGS. 1-4, there is depicted an exemplary use of the device 10. In operation, an object 22, such as a container containing a substance to be dispensed, is placed on the surface 14 of the pad 10, as depicted by the broken lines. The weight of the object 22 compresses the tubes 12 and forces the fluid 18 out of the tubes 12 in the region 20 of the pad 10 which is in alignment with the object 22.

When the object is later removed, e.g., for use by a user 24, the impression 20 of the object 22 remains in the pad 10 due to the high viscosity of the fluid material 18 which prevents the fluid 22 from immediately flowing back into the compressed region 20. In this manner, the impression 20, which persists after the object 22 is removed, serves as a memory aid to the user 24 as to whether the object 22 had, in fact, been used. A desired persistence time of the compressed region 20 may be achieved by a number of factors, such as the fluid 22 viscosity, resilience of the flexible tubes 12, and others. The memory retention time may range from several seconds to several minutes, or longer.

The invention has been described with reference to the preferred embodiment. Modifications and alterations will occur to others upon a reading and understanding of the preceding detailed description. It is intended that the invention be construed as including all such modifications and alterations.

What is claimed is:

1. An indenting memory device comprising:
a plurality of flexible tubes forming a pad, said flexible tubes comprising a sealed interior space; and
a viscous fluid contained within said sealed interior space, such that a deformation of a portion of said device will persist for a period of time.

2. The device of claim 1, wherein said flexible tubes are intersecting.

3. The device of claim 1, wherein said flexible tubes are woven.

4. The device of claim 1, wherein said flexible tubes have a noncircular cross-sectional shape.

5. The device of claim 1, wherein said flexible tubes have an elliptical cross-sectional shape.

6. The device of claim 1, wherein said flexible tubes have a circular cross-sectional shape.

7. The device of claim 1, wherein said flexible tubes have a diameter of less than or equal to about 2 millimeters.

8. The device of claim 1, wherein said flexible tubes have a diameter of less than or equal to about 1 millimeter.

9. The device of claim 1, wherein the fluid has a viscosity in the range of from about 100,000 centistokes to about five million centistokes.

10. The device of claim 1, wherein the fluid comprises a fluid material selected from one or more of silicones, fluorocarbon materials, and gels.

11. The device of claim 1, wherein said period of time is in the range of from about several seconds to several minutes.

12. A method for providing a reminder, comprising:
providing a sensing surface including a plurality of flexible tubes forming a pad, said flexible tubes comprising a sealed interior space and a viscous fluid contained within said sealed interior space, such that a deformation of a portion of said device will persist for a period of time; and
receiving an object on said sensing surface to form a region of deformation on said surface, said region of deformation thereby serving providing an indicium of the presence of object for said period of time after the object is removed.

13. The method of claim 12, wherein said flexible tubes are intersecting.

14. The method of claim 12, wherein said flexible tubes are woven.

15. The method of claim 12, wherein said flexible tubes have a noncircular cross-sectional shape.

16. The method of claim 12, wherein said flexible tubes have an elliptical cross-sectional shape.

17. The method of claim 12, wherein said flexible tubes have a circular cross-sectional shape.

18. The method of claim 12, wherein said flexible tubes have a diameter of less than or equal to about 2 millimeters.

19. The method of claim 12, wherein said flexible tubes have a diameter of less than or equal to about 1 millimeter.

20. The method of claim 12, wherein the fluid has a viscosity in the range of from about 100,000 centistokes to about five million centistokes.

21. The method of claim 12, wherein the fluid comprises a fluid material selected from one or more of silicones, fluorocarbon materials, and gels.

22. The method of claim 12, wherein said period of time is in the range of from about several seconds to several minutes.
